(19) United States
(12) Patent Application Publication
(10) Pub. No.: US 2022/0359876 A1
(43) Pub. Date: Nov. 10, 2022

(54) CONDUCTIVE MATERIAL DISPERSION LIQUID AND ELECTRODE PASTE FOR LITHIUM-ION SECONDARY BATTERY POSITIVE ELECTRODE

(71) Applicant: MIKUNI-COLOR LTD., Hyogo (JP)

(72) Inventors: Yukiko MATSUO, Tokyo (JP); Tomohiro HASHIZUME, Tokyo (JP); Masaya OMURA, Tokyo (JP); Rie KAJIHARA, Hyogo (JP)

(73) Assignee: MIKUNI-COLOR LTD., Hyogo (JP)

(21) Appl. No.: 17/756,555

(22) PCT Filed: Oct. 22, 2020
(86) PCT No.: PCT/JP2020/039749

§ 371 Date: May 26, 2022

(30) Foreign Application Priority Data
Nov. 27, 2019 (JP) 2019-214665

(51) Int. Cl. H01M 4/62; C08K 3/04

(52) U.S. Cl. CPC H01M 4/621; H01M 4/625; C08K 3/04; C08K 3/041; H01M 2004/028

(57) ABSTRACT

Provided is a conductive material dispersion liquid for a lithium-ion secondary battery positive electrode, containing a conductive material, methyl octyl cellulose, and a dispersion medium.

### TECHNICAL FIELD

The present invention relates to conductive material dispersion liquids and electrode pastes for a lithium-ion secondary battery positive electrode.

### BACKGROUND ART

In recent years, with the spread of mobile phones, notebook personal computers, and the like, lithium-ion secondary batteries have been attracting attention. A lithium-ion secondary battery usually includes a negative electrode made of a carbon material, a positive electrode containing an active material that allows lithium ions to reversibly move in and out, and a non-aqueous electrolyte that immerses the negative electrode and the positive electrode therein.

Among these components, the positive electrode is produced by applying an electrode paste containing a positive electrode active material, a conductive material, and a binder, to a current collector plate. As the positive electrode active material, a lithium transition metal composite oxide or the like is used. Such a positive electrode active material alone lacks electron conductivity, that is, electric conductivity. Thus, in order to impart electric conductivity, a carbon material such as conductive carbon black having a highly developed structure, graphite whose crystals exhibit remarkable anisotropy, or the like is added as a conductive material, and dispersed together with a binder (binding material) in a non-aqueous solvent such as N-methyl-2-pyrrolidone (NMP) to prepare a slurry, and the slurry is applied onto a metal foil and dried to form a positive electrode.

However, carbon black and graphite, which are carbon materials used as conductive materials, are each fine powder having a small primary particle diameter and have a strong cohesive force due to its large structure and specific surface area, so that it is difficult to uniformly mix and disperse the carbon material in a slurry for forming an electrode mixture for a lithium-ion secondary battery. When the dispersibility and the particle size of a carbon material that is a conductive material are not sufficiently controlled, a uniform conductive network is not formed, and thus the internal resistance of the electrode cannot be reduced, resulting in a problem that the performance of a lithium transition metal composite oxide, which is a positive electrode active material, graphite, which is a carbon material, and the like cannot be sufficiently brought out. In addition, if the conductive material (conductive aid) is not sufficiently dispersed in the electrode mixture, a resistance distribution may occur on an electrode plate due to partial aggregation, and concertation of a current may occur during use as a battery, resulting in a problem that partial heat generation, accelerated deterioration, or the like occurs.

It is proposed that in order to uniformly disperse a conductive material in an electrode, a dispersion liquid (conductive material dispersion liquid) is prepared in advance by dispersing and slurring the conductive material in a dispersion medium such as an organic solvent or the like together with a dispersant, and is kneaded with an active material and a binder to form an electrode (Patent Literature 1). A battery dispersant that stabilizes the dispersion of a conductive aid without impairing the electric conductivity of the conductive aid and improves the wettability of the conductive aid with respect to an electrolyte, is proposed (Patent Literature 2). In addition, a conductive material dispersion liquid that can ensure good dispersibility and electric conductivity is proposed (Patent Literature 3).

### CITATION LIST

### Patent Literature

Patent Literature 1: JP2018-129305
Patent Literature 2: JP2012-195243
Patent Literature 3: JP Patent No. 5628503

### SUMMARY OF THE INVENTION

### Problems to be Solved by the Invention

However, the conventional conductive material dispersion liquid has insufficient storage stability, and tends to change its viscosity such as increasing the viscosity over time. When such a conductive material dispersion liquid is kneaded together with an active material and a binder to form an electrode, the workability is inferior.

An object of the present disclosure is to provide a conductive material dispersion liquid, for a lithium-ion secondary battery positive electrode, which has excellent viscosity storage stability.

### Solution to the Problems

A first aspect of the present disclosure is directed to a conductive material dispersion liquid for a lithium-ion secondary battery positive electrode, containing a conductive material, methyl octyl cellulose, and a dispersion medium.

In the conductive material dispersion liquid for a lithium-ion secondary battery positive electrode, the conductive material may be at least one carbon black selected from the group consisting of acetylene black, furnace black, and Ketjen black, a contained amount of the carbon black in the dispersion liquid may be equal to or greater than 5% by mass and equal to or less than 30% by mass, and a viscosity of the dispersion liquid measured using a B-type viscosity meter may be equal to or greater than 50 mPa·s and equal to or less than 2000 mPa·s.

In the conductive material dispersion liquid for a lithium-ion secondary battery positive electrode, the conductive material may be carbon nanotube, a contained amount of the carbon nanotube in the dispersion liquid may be equal to or greater than 0.1% by mass and equal to or less than 10% by mass, and a viscosity of the dispersion liquid measured using a B-type viscosity meter may be equal to or greater than 50 mPa·s and equal to or less than 2000 mPa·s.

In the conductive material dispersion liquid for a lithium-ion secondary battery positive electrode, the methyl octyl cellulose may have a degree of methyl group substitution of not less than 0.1 and less than 2.9, a degree of octyl group substitution of not less than 0.01 and less than 2.9, and a sum of the degree of methyl group substitution and the degree of octyl group substitution of less than 3.0, and a contained amount of the methyl octyl cellulose per 100 parts by mass of the carbon black may be equal to or greater than 0.1 parts by mass and equal to or less than 30 parts by mass.

In the conductive material dispersion liquid for a lithium-ion secondary battery positive electrode, the methyl octyl cellulose may have a degree of methyl group substitution of not less than 0.1 and less than 2.9, a degree of octyl group substitution of not less than 0.01 and less than 2.9, and a sum of the degree of methyl group substitution and the degree of octyl group substitution of less than 3.0, and a contained amount of the methyl octyl cellulose per 100 parts by mass of the carbon nanotube may be equal to or greater than 30 parts by mass and equal to or less than 200 parts by mass.

In the conductive material dispersion liquid for a lithium-ion secondary battery positive electrode, the dispersion medium may be N-methyl-2-pyrrolidone.

A second aspect of the present disclosure is directed to an electrode paste for a lithium-ion secondary battery positive electrode, containing the conductive material dispersion liquid, an active material, and a binder.

### Advantageous Effects of the Invention

The conductive material dispersion liquid for a lithium-ion secondary battery positive electrode of the present disclosure has excellent viscosity storage stability.

### DESCRIPTION OF EMBODIMENTS

[Conductive Material Dispersion Liquid]

A conductive material dispersion liquid of the present disclosure is a conductive material dispersion liquid for a lithium-ion secondary battery positive electrode, containing a conductive material, methyl octyl cellulose, and a dispersion medium.

(Dispersion Liquid)

The conductive material dispersion liquid refers to a liquid in which, among the contained components, at least the conductive material is dispersed in the dispersion medium, and is preferably in a state where the conductive material and the methyl octyl cellulose are dispersed. In addition, the conductive material dispersion liquid is preferably in a state where all the contained components are dispersed in the dispersion medium, regardless of whether or not other optional components are contained. Here, the state of being dispersed includes both suspension and solution states.

(Conductive Material)

The conductive material is a substance that has electric conductivity and enhances the electric conductivity of an electrode. As the conductive material, a conventionally known substance can be used, and examples of the conductive material include carbon black and carbon nanotube.

Carbon black is particulate carbon. Carbon black is particles whose characteristics change depending on the production method therefor, so that the quality (particle diameter, structure, crystallinity, and the like) is controlled by the production method, and carbon black is classified according to the production method. Examples of carbon black include acetylene black, furnace black, Ketjen black, channel black, thermal black, and the like. In addition, one of these carbon blacks can be used solely, or two or more of these carbon blacks can be used in combination.

From the viewpoint of increasing the capacity of a battery and improving the cycle characteristics, the conductive material is preferably at least one material selected from the group consisting of acetylene black, furnace black, Ketjen black, and carbon nanotube. One of these materials can be used solely, or two or more of these materials can be used in combination.

The average primary particle diameter of the carbon black may be 50 nm or less, and is preferably not greater than 40 nm, and more preferably not greater than 30 nm. In addition, the average primary particle diameter may be 10 nm or greater, and may be 15 nm or greater. If the average primary particle diameter of the carbon black is excessively large, the electric conductivity of a coating film obtained from an electrode paste tends to decrease. In addition, if the average primary particle diameter of the carbon black is excessively small, the viscosities of the conductive material dispersion liquid and the electrode paste become excessively high, so that it becomes difficult to disperse the carbon black and sufficient electric conductivity cannot be exhibited in some cases.

The average primary particle diameter indicates an arithmetic average particle diameter measured using a transmission electron microscope in accordance with ASTM: D3849-14. Generally, the average primary particle diameter is used to evaluate the physical properties of the conductive material.

The dispersed particle diameter of the carbon black in the dispersion liquid is preferably not greater than 40 μm and further preferably not greater than 30 μm as a maximum particle diameter. Generally, the average particle diameter is used to control the particle state of a dispersion such as a conductive material and the like. However, when the average particle diameter is used, since the existence of coarse particles is not taken into consideration, even if the value of the average particle diameter is small, coarse particles having a maximum particle diameter exceeding 40 μm may actually exist. In this case, the distribution of the active material and the conductive material in an electrode coating film for a lithium-ion secondary battery may become non-uniform, which may impair the battery performance.

The maximum particle diameter may be measured using a grind gauge in accordance with JIS K5600-2-5.

The purity of the carbon black may be 99.90 to 100% by mass, and is preferably 99.95 to 100% by mass. The purity of the carbon black can be calculated based on the amount of impurities that are the ash content measured in accordance with JIS K1469 or JIS K6218.

Carbon nanotube is carbon crystals having a substantially cylindrical shape. The average outer diameter of the carbon nanotube may be 90 nm or less, and is preferably not greater than 30 nm, preferably not greater than 20 nm, and further preferably not greater than 15 nm. In addition, the average outer diameter may be 1 nm or greater, or 5 nm or greater. If the average outer diameter of the carbon nanotube is excessively large, the electric conductivity of the coating film obtained from the electrode paste tends to decrease. If the average outer diameter of the carbon nanotube is excessively small, the viscosities of the conductive material dispersion liquid and the electrode paste may become excessively high, so that it may be difficult to disperse the carbon nanotube.

The average outer diameter of the carbon nanotube is the arithmetic mean value of a sufficient number n of outer diameters measured using an image taken at a magnification of 100,000 times or more by a transmission electron microscope.

Specific examples of the carbon nanotube include VGCF-X (average outer diameter: 30 nm) manufactured by Showa Denko K.K., C100 (average outer diameter: 10 to 15 nm) and U100 (average outer diameter: 10 to 15 nm, high purity product) manufactured by ARKEMA, NC7000 (average outer diameter: 10 nm), NC2150, and NC3100 manufactured by Nanocyl, Baytubes C150 (average outer diameter: 13 to 16 nm) and Baytubes C150P (average outer diameter: 13 to 16 nm) manufactured by BAYER, MWNT (average outer diameter: 40 to 90 nm) manufactured by Hodogaya Chemical Co., Ltd., and the like. In addition, one of these carbon nanotubes can be used solely, or two or more of these carbon nanotubes can be used in combination.

In the case where the conductive material dispersion liquid of the present disclosure contains carbon nanotube, it is preferable if the carbon nanotube molecules are dispersed independently one by one without aggregation. This is because the coating film obtained from the electrode paste has excellent electric conductivity.

The purity of the carbon nanotube may be 90 to 100% by mass, and is preferably 95 to 100% by mass. Similar to the purity of the carbon black, the purity of the carbon nanotube can be calculated based on the amount of impurities that are the ash content measured in accordance with JIS K1469 or JIS K6218.

The contained amount of the conductive material in the conductive material dispersion liquid is not particularly limited. In the case where the conductive material is carbon black, the contained amount of the carbon black in the conductive material dispersion liquid is preferably not less than 5% by mass, more preferably not less than 8% by mass, and further preferably not less than 12% by mass. In addition, the contained amount of the carbon black in the conductive material dispersion liquid is preferably not greater than 30% by mass and more preferably not greater than 28% by mass.

In the case where the conductive material is carbon nanotube, the contained amount of the carbon nanotube in the conductive material dispersion liquid is preferably not less than 0.1% by mass, more preferably not less than 0.4% by mass, and further preferably not less than 2% by mass. In addition, the contained amount of the carbon nanotube in the conductive material dispersion liquid is preferably not greater than 10% by mass.

If the contained amount of the conductive material in the conductive material dispersion liquid is excessively small, the total solid content at the time of preparing the electrode paste decreases and the viscosity becomes lower than an appropriate viscosity, so that unevenness occurs and a non-uniform coating film is formed. The non-uniform coating film refers to a coating film in which the active material and the conductive material are unevenly distributed, or a coating film whose weight per unit area (applied amount on a current collector) varies depending on the position. When a lithium-ion secondary battery having a coating film in which the active material and the conductive material are unevenly distributed, as a positive electrode, is produced, the electric conductivity may be lowered, or the electric charge may be made un-uniform, so that performance such as high-speed charging/discharging and durability may be impaired. When a plurality of lithium-ion secondary batteries are produced by using a coating film whose weight per unit area varies depending on the position, the capacity of each lithium-ion secondary battery varies, so that the yield may deteriorate. If the contained amount of the conductive material in the conductive material dispersion liquid is excessively large, the fluidity of the conductive material dispersion liquid may decrease, and the handling at the time of preparing the electrode paste may deteriorate.

(Methyl Octyl Cellulose)

Methyl octyl cellulose is a cellulose in which some or all of hydrogens in hydroxyl groups are substituted with methyl groups and octyl groups.

The degree of methyl group substitution of the methyl octyl cellulose is preferably not less than 0.1, more preferably not less than 1.0, and further preferably not less than 1.5. In addition, the degree of methyl group substitution is preferably less than 2.9, more preferably less than 2.5, and further preferably less than 2.0. If the degree of methyl group substitution is excessively low, the solubility in a solvent becomes poor. If the degree of methyl group substitution is excessively high, it becomes difficult to introduce octyl groups during production of the methyl octyl cellulose.

The degree of octyl group substitution of the methyl octyl cellulose is preferably not less than 0.01, more preferably not less than 0.05, and further preferably not less than 0.08. In addition, the degree of octyl group substitution is preferably less than 2.9, more preferably less than 1.8, further preferably less than 0.8, particularly preferably less than 0.7, and most preferably less than 0.5. This is because the viscosity of the conductive material dispersion liquid is more stable over time. If the degree of octyl group substitution is excessively high, when the conductive material dispersion liquid is prepared, the viscosity of the conductive material dispersion liquid tends to increase.

The sum of the degree of methyl group substitution and the degree of octyl group substitution of the methyl octyl cellulose is preferably less than 3.0, more preferably less than 2.5, and further preferably less than 2.2. This is because it is necessary to lengthen the reaction time in order to increase the sum of the degrees of substitution, which results in a decrease in productivity and physical properties.

The sum of the degrees of substitution of the respective substituents of the methyl octyl cellulose is referred to as total degree of substitution, and the total degree of substitution of the methyl octyl cellulose is preferably not less than 0.3, more preferably not less than 1.0, and further preferably not less than 1.5. In addition, the total degree of substitution is preferably less than 3.0, more preferably less than 2.9, more preferably less than 2.5, and further preferably less than 2.2.

The degree of alkyl group substitution including the degree of methyl group substitution and the degree of octyl group substitution can be measured by the following method. The degree of alkyl group substitution can be measured by a method conforming to ASTM: D-817-91 or by ¹³C-NMR or ¹H-NMR.

An example of the conditions for quantifying the degree of methyl group substitution and the degree of octyl group substitution of the methyl octyl cellulose by ¹H-NMR is described below.

Apparatus: JEOL JNM ECA-500

Temperature: 80° C.

Solvent: DMSO

Sample concentration: 0.8 wt %

Calculation:
Degree of methyl group substitution=35β/(15α−15β−2γ)
Degree of octyl group substitution=7γ/(15α−15β−2γ)
α: integral value of 5.40 to 2.70 ppm
β: integral value of 3.51 to 3.41 and 3.32 to 3.25 ppm
γ: integral value of 1.65 to 0.70 ppm

The weight-average molecular weight (Mw) of the methyl octyl cellulose is not particularly limited, but is preferably not less than 1.0×10⁴, more preferably not less than 2.0×10⁴, and further preferably not less than 3.0×10⁴. In addition, the weight-average molecular weight is preferably not greater than 1.0×10⁶, more preferably not greater than 5.0×10⁵, and further preferably not greater than 2.0×10⁵. When the weight-average molecular weight is in this range, the dispersibility of the methyl octyl cellulose in the conductive material dispersion liquid and the workability during production of the dispersion liquid become good.

The weight-average molecular weight is a so-called weighted average value of molecular weight, which is obtained by multiplying the weight of each molecule by the molecular weight to obtain an average value, and can be measured by GPC.

The contained amount of the methyl octyl cellulose in the conductive material dispersion liquid is not particularly limited. However, if the contained amount of the methyl octyl cellulose in the conductive material dispersion liquid is excessively small, the dispersion of the conductive material becomes insufficient, and the electric conductivity of a coating film obtained from an electrode paste using this conductive material dispersion liquid tends to decrease. If the contained amount of the methyl octyl cellulose in the conductive material dispersion liquid is excessively large, the resistance component in a coating film obtained from an electrode paste using this conductive material dispersion liquid is increased, so that the electric conductivity of the coating film decreases. When a lithium-ion secondary battery having a positive electrode composed of such a coating film is produced, it may become difficult to increase the capacity of the battery.

For example, in the case where the conductive material is carbon black, the contained amount of the methyl octyl cellulose in the conductive material dispersion liquid per 100 parts by mass of the conductive material (carbon black) is preferably not less than 0.1 parts by mass, preferably not less than 3 parts by mass, more preferably not less than 5 parts by mass, and further preferably not less than 6 parts by mass. In addition, the contained amount of the methyl octyl cellulose is preferably not greater than 30 parts by mass, more preferably not greater than 15 parts by mass, and further preferably not greater than 10 parts by mass. When the contained amount of the methyl octyl cellulose is in the above range, the dispersibility of the conductive material dispersion liquid is excellent.

Moreover, for example, in the case where the conductive material is carbon nanotube, the contained amount of the methyl octyl cellulose in the conductive material dispersion liquid per 100 parts by mass of the conductive material (carbon nanotube) is preferably not less than 30 parts by mass and preferably not less than 50 parts by mass. In addition, the contained amount of the methyl octyl cellulose is preferably not greater than 200 parts by mass and more preferably not greater than 150 parts by mass. When the contained amount of the methyl octyl cellulose is in the above range, the dispersibility of the conductive material dispersion liquid is excellent.

The methyl octyl cellulose can be produced, for example, as follows. An example of the production method is a production method including: a step of converting a cellulose raw material into an alkaline cellulose under a basic condition (activation step); and a step of reacting the alkaline cellulose with an alkyl halide (etherification treatment). A more specific example of the production method is a method in which a cellulose raw material is converted into an alkaline cellulose, the alkaline cellulose is reacted with methyl halide to produce methyl cellulose, and the methyl cellulose is then reacted with octyl halide under a basic condition to produce methyl octyl cellulose.

(Dispersion Medium)

As described above, the dispersion medium is a component that at least allows the conductive material to be dispersed to prepare a dispersion liquid. Examples of the dispersion medium include: aliphatic hydrocarbon-based dispersion media such as pentane, normal hexane, octane, cyclopentane, cyclohexane, and the like; aromatic hydrocarbon-based dispersion media such as benzene, toluene, xylene, cymene, and the like; aldehyde-based dispersion media such as furfural and the like; ketone-based dispersion media such as acetone, methyl ethyl ketone, cyclopentanone, cyclohexanone, and the like; ester-based dispersion media such as butyl acetate, ethyl acetate, methyl acetate, butyl propionate, ethylene glycol monoethyl ether acetate, propylene glycol monomethyl ether acetate, 3-methoxybutyl acetate, ethylene glycol diacetate, and the like; ether-based dispersion media such as tetrahydrofuran, dioxane, ethylene glycol dimethyl ether, and the like; alcohol-based dispersion media such as methanol, ethanol, normal propyl alcohol, isopropyl alcohol, butyl alcohol, octyl alcohol, cyclohexanol, allyl alcohol, benzyl alcohol, cresol, furfuryl alcohol, and the like; polyol-based dispersion medium such as glycerol, ethylene glycol, diethylene glycol, and the like; alcohol ether-based dispersion media such as ethylene glycol monomethyl ether, ethylene glycol monoethyl ether, ethylene glycol monobutyl ether, propylene glycol monomethyl ether, diethylene glycol monobutyl ether, and the like; aprotic polar dispersion media such as N-methyl-2-pyrrolidone (NMP), dimethylsulfoxide, dimethylformamide, and the like; water; and the like. One of these dispersion media can be used solely, or two or more of these dispersion media can be used in combination.

As the dispersion medium, a dispersion medium having high solubility of the methyl octyl cellulose is preferably used. For example, when an electrode paste, for a lithium-ion secondary battery positive electrode, containing the conductive material dispersion liquid of the present disclosure is prepared and applied to a current collector (aluminum foil), and the dispersion medium is then evaporated from the electrode paste to dry the electrode paste to produce a lithium-ion secondary battery positive electrode, the conductive material can be uniformly dispersed even if the concentration of the dispersion medium decreases and the concentrations of the other components become higher.

Among the above various dispersion media, aprotic polar dispersion media are preferable, and N-methyl-2-pyrrolidone (NMP) is more preferably used. This is because it is easy to prepare an electrode paste containing the conductive material dispersion liquid, and the coatability of the electrode paste to a current collector is also excellent.

The contained amount of the dispersion medium in the conductive material dispersion liquid is not particularly limited, but in the case where the conductive material is carbon black, the dispersion medium is contained such that the concentration of the solid content in the conductive material dispersion liquid is preferably not less than 5% by mass, more preferably not less than 10% by mass, and further preferably not less than 13% by mass. In addition, in the case where the conductive material is carbon nanotube, the dispersion medium is contained such that the concentration of the solid content in the conductive material dispersion liquid is preferably not less than 0.2% by mass, more preferably not less than 1% by mass, and further preferably not less than 3% by mass.

The concentration of the solid content in the conductive material dispersion liquid can be calculated based on the residue obtained when about 1 g of a conductive material dispersion liquid sample is heated at 170° C. for 2 hours.

(Viscosity)

The viscosity of the conductive material dispersion liquid is not particularly limited, but is preferably not less than 50 mPa·s, more preferably not less than 80 mPa·s, and further preferably not less than 100 mPa·s at 25° C. under atmospheric pressure. In addition, the viscosity of the conductive material dispersion liquid is preferably not greater than 2000 mPa·s, more preferably not greater than 1800 mPa·s, and further preferably not greater than 1500 mPa·s. This is because it is easy to prepare an electrode paste containing the conductive material dispersion liquid, and the coatability of the electrode paste to a current collector is also excellent. If the viscosity of the conductive material dispersion liquid is excessively high, the coatability of the electrode paste containing the conductive material dispersion liquid, to a current collector, may be inferior.

The viscosity of the conductive material dispersion liquid may be measured in accordance with JIS K7117-1 using a B-type viscosity meter.

(Optional Component)

The conductive material dispersion liquid of the present disclosure may contain optional components other than the conductive material, the methyl octyl cellulose, and the dispersion medium, as appropriate within the scope of the object of the present disclosure. Examples of such optional components include conventionally known additives such as: dispersants; phosphorus compounds; sulfur compounds; organic acids; nitrogen compounds such as amine compounds, ammonium compounds, and the like; organic esters; various silane-based, titanium-based, and aluminum-based coupling agents; and the like. One of these optional components can be used solely, or two or more of these optional components can be used in combination.

Examples of the dispersants include nonionic dispersants such as polyvinylidene fluoride (PVDF), polytetrafluoroethylene, polyhexafluoropropylene, polyethylene, polypropylene, polymethyl methacrylate, polyvinyl chloride, polyvinylidene chloride, polyvinyl acetate, polyacrylic acid, polyvinyl butyral, polyacrylamide, polyurethane, polydimethylsiloxane, epoxy resin, acrylic resin, polyester resin, melamine resin, phenol resin, various rubbers, lignin, pectin, gelatin, xanthan gum, welan gum, succinoglycan, polyvinyl alcohol, polyvinyl acetal, cellulose-based resin (excluding methyl octyl cellulose), polyalkylene oxide, polyvinyl ether, polyvinyl pyrrolidone, chitins, chitosans, starches, and the like.

The blending amount of a dispersant per 100 parts by mass of the conductive material is preferably 0.1 to 100 parts by mass and more preferably 0.1 to 50 parts by mass.

Examples of phosphorus compounds include tributylphosphine, triphenylphosphine, triethyl phosphite, triphenyl phosphite, and the like.

Examples of sulfur compounds include butanethiol, n-hexanethiol, diethyl sulfide, tetrahydrothiopene, and the like.

Examples of organic acids include acetic acid, propionic acid, butyric acid, caproic acid, acrylic acid, crotonic acid, capric acid, stearic acid, oleic acid, oxalic acid, succinic acid, adipic acid, maleic acid, glutaric acid, benzoic acid, 2-methylbenzoic acid, 4-methylbenzoic acid, mixtures of two or more thereof, and the like.

Examples of amine compounds include methylamine, ethylamine, n-propylamine, n-butylamine, n-hexylamine, n-heptylamine, 2-ethylhexylamine, n-octylamine, nonylamine, decylamine, dodecylamine dococylamine, hexadecylamine, octadecylamine, isopropylamine, isobutylamine, isooctylamine, isoamylamine, allylamine, cyanoethylamine, cyclopropylamine, cyclohexylamine, cyclopentylamine, aniline, N,N-dimethylaniline, benzylamine, anisidine, aminobenzonitrile, piperidine, pyrazine, pyridine, pyrrole, pyrrolidine, methoxyamine, methoxyethylamine, methoxyethoxyethylamine, methoxyethoxyethoxyethylamine, methoxypropylamine, ethoxyamine, n-butoxyamine, 2-hexyloxyamine, 2-amino-2-methyl-1-propanol, aminoacetaldehyde dimethylacetal, hydroxyamine, ethanolamine, diethanolamine, methyldiethanolamine, 2-hydroxypropylamine, N-ethyldiethanolamine, N-methyldiethanolamine, aminoethylethanolamine, dimethylethanolamine, triisopropanolamine, triethanolamine, ethylenediamine, propylenediamine, triethylenediamine, triethylenetetramine, hexamethylenediamine, 2-ethyldiamine, 2,2-(ethylenedioxy)bisethylamine, tetramethylpropylenediamine, morpholine, N-methylmorpholine, N-ethylmorpholine, N-methylpiperidine, dimethylamine, diethylamine, dipropylamine, diethylenetriamine, tri-n-butylamine, ammonium hydroxide, imidazole, diazabicycloundecene, diazabicyclooctane, taurine, hydrazine, hexamethyleneimine, polyallylamine, polyethyleneimine, dihydrazide adipate, and the like.

Examples of ammonium compounds include 2-ethylhexylammonium 2-ethylhexylcarbamate, 2-ethylhexylammonium 2-ethylhexylcarbonate, 2-cyanoethylammonium 2-cyanoethylcarbamate, 2-cyanoethylammonium 2-cyanoethylcarbonate, 2-methoxyethylammonium 2-methoxyethylcarbamate, 2-methoxyethylammonium 2-methoxyethylcarbonate, n-butylammonium n-butylcarbamate, n-butylammonium n-butylcarbonate, t-butylammonium t-butylcarbamate, t-butylammonium t-butylcarbonate, isobutylammonium isobutylcarbamate, isobutylammonium isobutylcarbonate, isopropylammonium isopropylcarbamate, triethylenediaminium isopropylcarbamate, isopropylammonium isopropylcarbonate, triethylenediaminium isopropylcarbonate, ethylammonium ethylcarbamate, pyridinium ethylhexylcarbamate, ethylammonium ethylcarbonate, octadecylammonium octadecylcarbamate, octadecylammonium octadecylcarbonate, ammonium carbamate, dioctadecylammonium dioctadecylcarbamate, dioctadecylammonium dioctadecylcarbonate, dibutylammonium dibutylcarbamate, dibutylammonium dibutylcarbonate, triethoxysilylpropylammonium triethoxysilylpropylcarbamate, triethoxysilylpropylammonium triethoxysilylpropylcarbonate, hexamethyleneiminium hexamethyleneiminecarbamate, hexamethyleneiminium ammonium hexamethyleneiminecarbonate, benzylammonium benzylcarbamate, benzylammonium benzylcarbonate, methyldecylammonium methyldecylcarbamate, methyldecylammonium methyldecylcarbonate, morpholinium morpholinecarbamate, morpholinium morpholinecarbonate, 2-ethylhexylammonium bicarbonate, 2-cyanoethylammonium bicarbonate, 2-methoxyethylammonium bicarbonate, t-butylammonium bicarbonate, ammonium bicarbonate, isopropylammonium bicarbonate, dioctadecylammonium bicarbonate, triethylenediaminium bicarbonate, pyridinium bicarbonate, and the like, derivatives or mixtures thereof, and the like.

Examples of organic esters include ethyl acetate, isobutyl acetate, n-butyl acetate, methyl propionate, ethyl propionate, methyl butyrate, methyl acrylate, dimethyl oxalate, dimethyl succinate, methyl crotate, methyl benzoate, methyl 2-methylbenzoate, mixtures thereof, and the like.

Examples of silane coupling agents include vinyltrimethoxysilane, γ-methacryloxypropyl-tris(β-methoxyethoxy)silane, β-(3,4-epoxycyclohexyl)ethyltrimethoxysilane, γ-glycidoxypropyltrimethoxysilane, vinyltriacetoxysilane, γ-mercaptopropyltrimethoxysilane, γ-methacryloxypropyltrimethoxysilane, γ-aminopropyltriethoxysilane, N-β-(aminoethyl)-γ-aminopropyltrimethoxysilane, N-β-(aminoethyl)-γ-aminopropylmethylmethoxysilane, N-β-(aminoethyl)-γ-aminopropylmethyldimethoxysilane, N,N-bis(β-hydroxyethyl)-γ-aminopropyltriethoxysilane, γ-chloropropyltrimethoxysilane, vinyltris(2-methoxyethoxysilane), 2-(3,4-epoxycyclohexyl)ethyltrimethoxysilane, N-phenyl-γ-aminopropyltrimethoxysilane, γ-chloropropyltrimethoxysilane, and the like.

Examples of titanium coupling agents include tetrabutyl titanate, tetraoctyl titanate, isopropyltriisostearoyl titanate, isopropyl tridecyl benzene sulfonyl titanate, bis(dioctylpyrophosphate)oxyacetate titanate, trimethoxy titanate, tetramethoxy titanate, triethoxy titanate, tetraethoxy titanate, tetrapropoxy titanate, chlorotrimethoxy titanate, chlorotriethoxy titanate, ethyltrimethoxy titanate, methyltriethoxy titanate, ethyltriethoxy titanate, diethyldiethoxy titanate, phenyltrimethoxy titanate, phenyltriethoxy titanate, mixtures thereof, and the like.

Examples of aluminum-based coupling agents include various aluminum chelates, alkyl acetoacetate aluminum diisopropylate, aluminum/bisethyl acetate/diisopropyrate, acetoalkoxyaluminum diisopropylate, mixtures thereof, and the like.

(Production of Conductive Material Dispersion Liquid)

The method for producing the conductive material dispersion liquid of the present disclosure is not particularly limited, and the conductive material dispersion liquid can be produced, for example, by blending the conductive material, the methyl octyl cellulose, and the dispersion medium simultaneously or stepwise and stirring the mixture.

For example, after blending the conductive material, the methyl octyl cellulose, and the dispersion medium, the mixture may be stirred using a known mixing device such as a bead mill, a ball mill, or the like. At this time, in the case where the conductive material is carbon black, it is preferable to disperse the carbon black until the viscosity of the conductive material dispersion liquid falls within the above-described viscosity range. In addition, in the case where the conductive material is carbon nanotube, it is preferable to disperse the carbon nanotube until the carbon nanotube molecules become independent one by one.

[Electrode Paste]

An electrode paste of the present disclosure is an electrode paste for a lithium-ion secondary battery positive electrode, containing the conductive material dispersion liquid of the present disclosure, an active material, and a binder.

(Conductive Material Dispersion Liquid)

The contained amount of the conductive material dispersion liquid in the electrode paste is preferably adjusted such that the contained amount of the conductive material falls within the following range. In the case where the conductive material is carbon black, the contained amount of the conductive material per 100 parts by mass of the active material is preferably 0.5 to 15 parts by mass and more preferably 1 to 9 parts by mass. In addition, in the case where the conductive material is carbon nanotube, the contained amount of the conductive material per 100 parts by mass of the active material is preferably 0.05 to 15 parts by mass and more preferably 0.2 to 9 parts by mass.

If the ratio of the conductive material to the active material is excessively low, the electric conductivity is decreased, so that the battery characteristics may deteriorate. On the other hand, if the ratio of the conductive material to the active material is excessively high, coating of the conductive material on the surface of the active material becomes excessive, becoming a barrier that hinders movement of lithium ions, so that the battery characteristics may deteriorate.

(Active Material)

The active material is an active material for a lithium-ion secondary battery positive electrode. As the active material, a conventionally known active material can be used, and examples of the active material include: lithium transition metal oxides such as lithium cobalt oxide, lithium manganese oxide, lithium nickel oxide, lithium iron oxide, and the like; lithium iron phosphate; nickel manganese cobalt oxide; manganese oxide; and the like. Among these active materials, lithium transition metal oxides are preferable. In addition, one of these active materials can be used solely, or two or more of these active materials can be used in combination.

The contained amount of the active material in the electrode paste is preferably not less than 50% by mass and more preferably not less than 54% by mass. In addition, the contained amount of the active material is preferably not greater than 80% by mass and more preferably not greater than 78% by mass. If the contained amount of the active material is less than 50% by mass, unevenness may occur during solvent drying, and the coating film may become non-uniform. On the other hand, if the contained amount of the active material exceeds 80% by mass, the fluidity of an electrode slurry may significantly decrease, and it may become difficult to apply the electrode slurry.

(Binder)

As the binder, a conventionally known active material can be used, and examples of the binder include polyvinylidene fluoride (PVDF); polytetrafluoroethylene; polyhexafluoropropylene; polyethylene; polypropylene; polymethyl methacrylate; polyvinyl chloride; polyvinylidene chloride; polyvinyl acetate; polyacrylic acid; polyvinyl butyral; polyacrylamide; polyurethane; polydimethylsiloxane; epoxy resin; acrylic resin; polyester resin; melamine resin; phenol resin; various rubbers such as styrene butadiene rubber; lignin; pectin; gelatin; xanthan gum; welan gum; succinoglycan; polyvinyl alcohol; polyvinyl acetal; cellulose-based resin; polyalkylene oxide; polyvinyl ether; polyvinylpyrrolidone; chitins; chitosans; starches; and the like. One of these binders can be used solely, or two or more of these binders can be used in combination.

The contained amount of the binder in the electrode paste is preferably not less than 0.3% by mass and more preferably not less than 0.5% by mass, and is preferably not greater than 25% by mass and more preferably not greater than 20% by mass. If the contained amount of the binder is less than 0.3% by mass, the coatability may become insufficient. On the other hand, if the contained amount of the binder exceeds 25% by mass, the battery characteristics may deteriorate.

Moreover, the form of the binder is not limited, and the binder may be, for example, a solid in the form of powder, granules, and the like; or a liquid such as a solution and a dispersion liquid (dispersion, emulsion, and the like).

(Optional Components)

If necessary, the electrode paste of the present disclosure may contain optional components other than the conductive material dispersion liquid of the present disclosure, the active material, and the binder, as appropriate within the scope of the object of the present disclosure. Examples of such optional components include conventionally known additives such as a flame retardant aid, a thickener, a defoaming agent, a leveling agent, an adhesion imparting agent, and the like. One of these optional components can be used solely, or two or more of these optional components can be used in combination.

(Production of Electrode Paste)

The method for producing the electrode paste is not particularly limited, and the electrode paste can be produced, for example, by blending the conductive material dispersion liquid, the active material, the binder, and if necessary, a dispersion medium and various additives simultaneously or stepwise, and mixing these materials using various mixing machines such as a planetary mixer, a disperser, a ball mill, a blender mill, and the like.

[Usage]

The conductive material dispersion liquid and the electrode paste of the present disclosure are suitably used for a lithium-ion secondary battery positive electrode.

### EXAMPLES

Hereinafter, the present disclosure will be described in detail based on examples, but the technical scope thereof is not limited by these examples.

Various measurements in Examples and Comparative Examples were performed by the following methods.

<Degree of Substitution>

The degree of alkyl group substitution was quantified by ¹H-NMR under the following conditions.

Apparatus: JEOL JNM ECA-500

Temperature: 80° C.

Solvent: DMSO

Sample concentration: 0.8 wt %

Calculation:
Case of methyl octyl cellulose
   Degree of methyl group substitution=35β/(15α−15β−2γ)
   Degree of octyl group substitution=7γ/(15α−15ρ−2γ)
   α: integral value of 5.40 to 2.70 ppm
   β: integral value of 3.51 to 3.41 and 3.32 to 3.25 ppm
   γ: integral value of 1.65 to 0.70 ppm
Case of methyl butyl cellulose
   Degree of methyl group substitution=49β/3(7α−7β−2γ)
   Degree of butyl group substitution=7γ/(7α−7μ−2γ)
   α: integral value of 5.40 to 2.70 ppm
   β: integral value of 3.51 to 3.41 and 3.32 to 3.25 ppm
   γ: integral value of 1.65 to 0.70 ppm
Case of methyl hexyl cellulose
   Degree of methyl group substitution=77β/3(11α−11β−2γ)
   Degree of hexyl group substitution=7γ/(11α−11β−2γ)
   α: integral value of 5.40 to 2.70 ppm
   β: integral value of 3.51 to 3.41 and 3.32 to 3.25 ppm
   γ: integral value of 1.65 to 0.70 ppm

<N-Methyl-2-Pyrrolidone (NMP) Solubility>

The state after 2.5 parts by mass of a sample and 47.5 parts by mass of NMP were mixed at room temperature (20 to 25° C.) and the state after 2.5 parts by mass of the sample and 47.5 parts by mass of NMP were mixed at 100° C. were visually observed and evaluated according to the following criteria.

Excellent: Easily completely dissolved at room temperature.

Good: Completely dissolved by adjusting the temperature to 100° C.

Fair: Some undissolved gel remains even when the temperature is adjusted to 100° C.

Poor: Swollen or not dissolved even when the temperature is adjusted to 100° C.

<Solvent Resistance>

0.3 parts by mass of a sample and 5.7 parts by mass of a mixed solvent of ethylene carbonate:diethyl carbonate=1:1 as a solvent were added to a screw bottle having a capacity of about 10 ml, and the state after the bottle was held at 85° C. for 6 hours was visually observed and evaluated according to the following criteria.

Good: Not dissolved.

Fair: Swollen or gelled.

Poor: Partially dissolved or completely dissolved.

<Dispersion Liquid Viscosity and Dispersion Liquid Storage Stability>

1 part by mass of a sample, 13.5 parts by mass of DENKA BLACK Li Li-435, which is a conductive material, and 85.5 parts by mass of NMP were put in a plastic bottle, and the materials were dispersed using a paint shaker with zirconia beads as a medium until reaching the above-described viscosity (50 to 2000 mPa·s), to prepare a dispersion liquid. The viscosity of the dispersion liquid was measured in accordance with JIS K7117-1 at 25° C. under atmospheric pressure using a B-type viscosity meter.

The viscosity of the dispersion liquid immediately after preparation was calculated as a relative value when the value of the viscosity of a dispersion liquid containing methyl cellulose of Comparative Example 1 described below was regarded as 100. A lower value of the viscosity of the dispersion liquid is better.

The viscosity of each dispersion liquid after standing at 25° C. for 1 week was measured, and the storage stability of the dispersion liquid was calculated as a relative value when the value of the viscosity of the dispersion liquid immediately after preparation was regarded as 100. The closer to 100 the value is, the better the storage stability of the dispersion liquid is.

### Example 1

100 g of methyl cellulose (manufactured by FUJIFILM Wako Pure Chemical Industries Corporation, degree of methyl group substitution: 1.8) and 2000 mL of isopropyl alcohol were added to a 5000 mL separable flask equipped with a three-one motor, a reflux condenser, a thermometer, and a drop funnel, and the mixture was stirred at room temperature. Then, 250 g of a 48% by mass sodium hydroxide aqueous solution was added thereto, and the mixture was further stirred for 1 hour. 120 mL of octyl iodide was added dropwise thereto, and the mixture was further stirred at room temperature for 30 minutes. Then, after stirring at 70° C. for 5 hours, the temperature was returned to room temperature. The white solid was filtered off by suction filtration and then washed twice with water. The white solid was dried by heating at 80° C. for 12 hours to obtain 95 g of methyl octyl cellulose.

The “degree of substitution”, “NMP solubility”, and “solvent resistance” of the obtained methyl octyl cellulose, and the “dispersion liquid viscosity” and the “dispersion liquid storage stability” of a dispersion liquid containing the methyl octyl cellulose were obtained by the above methods, respectively. The results are shown in Table 1.

### Example 2

101 g of methyl octyl cellulose was obtained in the same manner as Example 1, except the addition amount of octyl iodide was changed to 270 ml. Various measurements of the obtained methyl octyl cellulose and a dispersion liquid containing the methyl octyl cellulose were also performed in the same manner. The results are shown in Table 1.

### Example 3

111 g of methyl octyl cellulose was obtained in the same manner as Example 1, except the addition amount of octyl iodide was changed to 510 ml. Various measurements of the obtained methyl octyl cellulose and a dispersion liquid containing the methyl octyl cellulose were also performed in the same manner. The results are shown in Table 1.

### Example 4

150 g of methyl octyl cellulose was obtained in the same manner as Example 1, except the addition amount of octyl iodide was changed to 1160 ml. Various measurements of the obtained methyl octyl cellulose and a dispersion liquid containing the methyl octyl cellulose were also performed in the same manner. The results are shown in Table 1.

### Example 5

92 g of methyl octyl cellulose was obtained in the same manner as Example 1, except methyl cellulose (DS1.0) obtained by Preparation Method 1 described below was used as methyl cellulose and the addition amount of octyl iodide was changed to 440 ml. Various measurements of the obtained methyl octyl cellulose and the dispersion liquid containing the methyl octyl cellulose were also performed in the same manner. The results are shown in Table 1.

(Preparation Method 1)

100 g of crushed pulp and 390 ml of a 48% by mass sodium hydroxide aqueous solution were added to a 3 L autoclave equipped with a stirrer, and the mixture was stirred at 45° C. for 1 hour under a nitrogen atmosphere (first step). After standing to cool, the mixture was cooled to −40° C. using a dry ice/methanol bath, stirred together with 150 ml of toluene and 310 g of chloromethane at 60° C. for 1 hour, and further stirred at 100° C. for 3 hours (second step). After returning the temperature to room temperature, the gas remaining in the system was exhausted, and the residue was added into 12 L of methanol with vigorous stirring to obtain a white solid (third step). The white solid was filtered off by suction filtration and washed 3 times with a large amount of isopropyl alcohol. The obtained white solid was vacuum dried at 80° C. for 15 hours to obtain methyl cellulose (DS1.0) as white powder.

### Example 6

101 g of methyl octyl cellulose was obtained in the same manner as Example 1, except methyl cellulose (DS0.48) obtained by Preparation Method 2 described below was used as methyl cellulose and the addition amount of octyl iodide was changed to 760 ml. Various measurements of the obtained methyl octyl cellulose and the dispersion liquid containing the methyl octyl cellulose were also performed in the same manner. The results are shown in Table 1.

(Preparation Method 2)

Methyl cellulose was obtained in the same manner as Preparation Method 1, except the amount of the 48% sodium hydroxide aqueous solution was changed to 200 ml and the amount of chloromethane was changed to 170 g.

### Comparative Example 1

As methyl cellulose, methyl cellulose (manufactured by FUJIFILM Wako Pure Chemical Industries Corporation, degree of methyl group substitution: 1.8) was used. Various measurements of this methyl cellulose and a dispersion liquid containing the methyl cellulose were also performed in the same manner. The results are shown in Table 1.

### Comparative Example 2

95 g of methyl butyl cellulose was obtained in the same manner as Example 1, except octyl iodide was changed to 190 ml of butyl iodide. Various measurements of the obtained methyl butyl cellulose and a dispersion liquid containing the methyl butyl cellulose were also performed in the same manner. The results are shown in Table 1.

### Comparative Example 3

98 g of methyl hexyl cellulose was obtained in the same manner as Example 1, except octyl iodide was changed to 238 ml of hexyl iodide. Various measurements of the obtained methyl hexyl cellulose and a dispersion liquid containing the methyl hexyl cellulose were also performed in the same manner. The results are shown in Table 1.

TABLE 1

| | | | | | | | | | | Compar- | Compar- |
|---|---|---|---|---|---|---|---|---|---|---|---|
| | | | | | | | | | Compar- | ative | ative |
| | | | | | | | | | ative | Exam- | Exam- |
| | | | | | | | | | Exam- | ple 2 | ple 3 |
| | | | Exam- | Exam- | Exam- | Exam- | Exam- | Exam- | ple 1 | Methyl | Methyl |
| | | | ple 1 | ple 2 | ple 3 | ple 4 | ple 5 | ple 6 | Methyl | butyl | hexyl |
| Classification | | | Methyl octyl cellulose | | | | | | cellulose | cellulose | cellulose |
| Composition | Degree of | Methyl group | 1.81 | 1.81 | 1.81 | 1.81 | 1.02 | 0.48 | 1.81 | 1.81 | 1.81 |
| | substitution | Butyl group | — | — | — | — | — | — | — | 0.30 | — |
| | | Hexyl group | — | — | — | — | — | — | — | — | 0.28 |
| | | Octyl group | 0.08 | 0.20 | 0.35 | 0.79 | 0.33 | 0.57 | — | — | — |
| | | Total degree of | 1.89 | 2.01 | 2.16 | 2.60 | 1.35 | 1.05 | 1.81 | 2.11 | 2.09 |
| | | substitution | | | | | | | | | |

| | | | | | | | | | | |
|---|---|---|---|---|---|---|---|---|---|---|
| Evaluation | NMP solubility | Excel- | Excel- | Excel- | Excel- | Good | Good | Good | Good | Good |
| | | lent | lent | lent | lent | | | | | |
| | Solvent resistance | Good | Good | Good | Good | Good | Good | Good | Poor | Fair |
| | Dispersion liquid viscosity | 174 | 127 | 283 | 367 | 203 | 240 | 100 | 258 | 283 |
| | (viscosity immediately after | | | | | | | | | |
| | preparation; relative value with | | | | | | | | | |
| | Comparative Example 1 as 100) | | | | | | | | | |
| | Dispersion liquid storage | 93 | 85 | 96 | 136 | 103 | 129 | 145 | 247 | 267 |
| | stability | | | | | | | | | |
| | (viscosity after one week; | | | | | | | | | |
| | relative value with value | | | | | | | | | |
| | immediately after preparation as | | | | | | | | | |
| | 100) | | | | | | | | | |

As shown in Table 1, the values of “dispersion liquid storage stability” of Comparative Examples 1, 2, and 3 are 145, 247 and 267, respectively, each of which is significantly increased from the value (100) of each dispersion liquid viscosity immediately after preparation. On the other hand, the value of the “dispersion liquid storage stability” of each Example is a value lower than 145 in Comparative Example 1 by 5 or more, so that each Example has excellent viscosity storage stability (a value lower than 145 in Comparative Example 1 by 5 or more has a significant difference). As described above, the conductive material dispersion liquid of each Example has excellent viscosity storage stability even when 1 week elapses from the preparation thereof.

Among the Examples, the values of “dispersion liquid storage stability” of Examples 1, 2, 3, and 5 in which the degree of octyl group substitution of the methyl octyl cellulose is preferable are 93, 85, 96, and 103, respectively, and are each almost unchanged from the value (100) of each dispersion liquid viscosity immediately after preparation, so that Examples 1, 2, 3, and 5 particularly have excellent viscosity storage stability.

1. A conductive material dispersion liquid for a lithium-ion secondary battery positive electrode, containing a conductive material, methyl octyl cellulose, and a dispersion medium.

2. The conductive material dispersion liquid for a lithium-ion secondary battery positive electrode according to claim 1, wherein
the conductive material is at least one carbon black selected from the group consisting of acetylene black, furnace black, and Ketjen black,
a contained amount of the carbon black in the dispersion liquid is not less than 5% by mass and not greater than 30% by mass, and
a viscosity of the dispersion liquid measured using a B-type viscosity meter is not less than 50 mPa·s and not greater than 2000 mPa·s.

3. The conductive material dispersion liquid for a lithium-ion secondary battery positive electrode according to claim 1, wherein
the conductive material is carbon nanotube,
a contained amount of the carbon nanotube in the dispersion liquid is not less than 0.1% by mass and not greater than 10% by mass, and
a viscosity of the dispersion liquid measured using a B-type viscosity meter is not less than 50 mPa·s and not greater than 2000 mPa·s.

4. The conductive material dispersion liquid for a lithium-ion secondary battery positive electrode according to claim 2, wherein
the methyl octyl cellulose has a degree of methyl group substitution of not less than 0.1 and less than 2.9, a degree of octyl group substitution of not less than 0.01 and less than 2.9, and a sum of the degree of methyl group substitution and the degree of octyl group substitution of less than 3.0, and
a contained amount of the methyl octyl cellulose per 100 parts by mass of the carbon black is not less than 0.1 parts by mass and not greater than 30 parts by mass.

5. The conductive material dispersion liquid for a lithium-ion secondary battery positive electrode according to claim 3, wherein
the methyl octyl cellulose has a degree of methyl group substitution of not less than 0.1 and less than 2.9, a degree of octyl group substitution of not less than 0.01 and less than 2.9, and a sum of the degree of methyl group substitution and the degree of octyl group substitution of less than 3.0, and
a contained amount of the methyl octyl cellulose per 100 parts by mass of the carbon nanotube is not less than 30 parts by mass and not greater than 200 parts by mass.

6. The conductive material dispersion liquid for a lithium-ion secondary battery positive electrode according to claim 1, wherein the dispersion medium is N-methyl-2-pyrrolidone.

7. An electrode paste for a lithium-ion secondary battery positive electrode, containing the conductive material dispersion liquid according to claim 5, an active material, and a binder.

8. An electrode paste for a lithium-ion secondary battery positive electrode, containing the conductive material dispersion liquid according to claim 6, an active material, and a binder.
